(19) United States
(12) Patent Application Publication
(10) Pub. No.: US 2014/0362482 A1
(43) Pub. Date: Dec. 11, 2014

(54) ELECTROSTATIC DISCHARGE STRUCTURE FOR ENHANCING ROBUSTNESS OF CHARGE DEVICE MODEL AND CHIP WITH THE SAME

(71) Applicant: MediaTek Inc., Hsin-Chu (TW)

(72) Inventors: Bo-Shih HUANG, Hsinchu City (TW); Tzung-Han WU, Hsinchu City (TW); Chi-Yao YU, Zhubei City (TW)

(73) Assignee: Media Tek Inc., Hsin-Chu (TW)

(21) Appl. No.: 13/911,645

(22) Filed: Jun. 6, 2013

(51) Int. Cl. H02H 9/04

(52) U.S. Cl. CPC H02H 9/046
USPC 361/56

(57) ABSTRACT

An ESD (Electrostatic discharge) structure for enhancing robustness of CDM (Charge Device Model) at least includes an input stage. The input stage includes an input pad, a first ESD clamp circuit, a second ESD clamp circuit, a resistor, and a transistor. The input pad is configured to receive an input signal. The first ESD clamp circuit is coupled between the input pad and a work voltage. The second ESD clamp circuit is coupled between the input pad and a ground voltage. The first clamp circuit and the second clamp circuit are capable of bypassing an electrostatic current. The transistor has a first source/drain, a second source/drain, a gate coupled to the input pad, and a bulk coupled through the resistor to the work voltage or the ground voltage.

### BACKGROUND OF THE INVENTION

1. Field of the Invention

The disclosure generally relates to an ESD (Electrostatic discharge) structure, and more particularly, relates to an ESD structure for enhancing robustness of a CDM (Charge Device Model).

2. Description of the Related Art

The CDM (Charge Device Model) is a model for characterizing the susceptibility of an electronic device to damage from ESD (Electrostatic discharge). The model is an alternative to the HBM (Human-Body Model). Devices that are classified according to CDM are exposed to a charge at a standardized voltage level, and then tested for survival. If it withstands a voltage level, it is tested at the next level and so on, until the device fails.

To enhance the robustness of CDM, a conventional method is to incorporate a pair of CDM clamp circuits into an IC (Integrated Circuit). However, the additional CDM clamp circuits often increase the burden of the whole system in the IC, and degrade the performance thereof.

### BRIEF SUMMARY OF THE INVENTION

In one exemplary embodiment, the disclosure is directed to an ESD (Electrostatic discharge) structure for enhancing robustness of CDM (Charge Device Model), comprising: an input stage, comprising: an input pad, configured to receive an input signal; a first ESD clamp circuit, coupled between the input pad and a work voltage; a second ESD clamp circuit, coupled between the input pad and a ground voltage, wherein the first ESD clamp circuit and the second ESD clamp circuit are capable of bypassing an excessive electrostatic current; a resistor; and a transistor, wherein the transistor has a first source/drain, a second source/drain, a gate coupled to the input pad, and a bulk coupled to the work voltage or the ground voltage through the resistor.

In another exemplary embodiment, the disclosure is directed to a chip with an ESD structure for enhancing robustness of CDM, comprising: a first power domain, supplied by a first work voltage, and generating a first signal; and a second power domain, supplied by a second work voltage, and generating a second signal according to the first signal, wherein the second power domain comprises: a resistor; and a transistor, wherein the transistor has a first source/drain, a second source/drain, a gate for receiving the first signal, and a bulk coupled to the second work voltage or a ground voltage through the resistor.

### BRIEF DESCRIPTION OF DRAWINGS

The invention can be more fully understood by reading the subsequent detailed description and examples with references made to the accompanying drawings, wherein:

FIG. 1 is a diagram for illustrating an ESD (Electrostatic discharge) structure for enhancing robustness of CDM (Charge Device Model) according to an embodiment of the invention;

FIG. 2A is a diagram for illustrating an ESD structure according to an embodiment of the invention;

FIG. 2B is a diagram for illustrating an ESD structure according to another embodiment of the invention;

FIG. 3 is a diagram for illustrating a chip with an ESD structure for enhancing robustness of CDM according to an embodiment of the invention;

FIG. 4 is a diagram for illustrating a chip according to an embodiment of the invention;

FIG. 5 is a diagram for illustrating a chip according to an embodiment of the invention;

FIG. 6 is a diagram for illustrating a chip according to an embodiment of the invention;

FIG. 7 is a diagram for illustrating a chip according to an embodiment of the invention;

FIG. 8 is a diagram for illustrating a detail structure of an NMOS transistor and a resistor coupled thereto according to an embodiment of the invention; and

FIG. 9 is a diagram for illustrating a detail structure of a PMOS transistor and a resistor coupled thereto according to an embodiment of the invention.

### DETAILED DESCRIPTION OF THE INVENTION

In order to illustrate the purposes, features and advantages of the invention, the embodiments and figures thereof in the invention are shown in detail as follows.

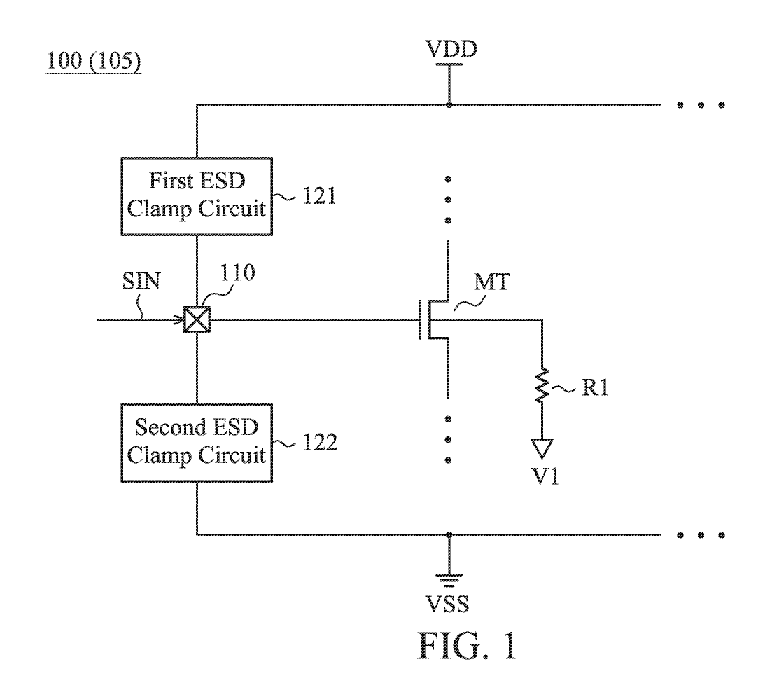

FIG. 1 is a diagram for illustrating an ESD (Electrostatic discharge) structure 100 for enhancing robustness of CDM (Charge Device Model) according to an embodiment of the invention. The ESD structure 100 at least comprises an input stage 105. As shown in FIG. 1, the input stage 105 comprises an input pad 110, a first ESD clamp circuit 121, a second ESD clamp circuit 122, a resistor R1, and a transistor MT. The input stage 105 may be coupled to other circuits (e.g., an input terminal of an amplifier, but not limited thereto).

The input pad 110 is configured to receive an input signal SIN. In some embodiments, the input pad 110 is made of a small metal board. The first ESD clamp circuit 121 is coupled between the input pad 110 and a work voltage VDD. The second ESD clamp circuit 122 is coupled between the input pad 110 and a ground voltage VSS. Generally, the first ESD clamp circuit 121 and the second ESD clamp circuit 122 are capable of bypassing an excessive electrostatic current which is input to the input pad 110, and accordingly protect the whole system from being damaged by the excessive electrostatic current. In some embodiments, the transistor MT is an NMOS transistor (N-channel Metal-Oxide-Semiconductor Field-Effect Transistor) or a PMOS transistor (P-channel Metal-Oxide-Semiconductor Field-Effect Transistor). The transistor MT has a first source/drain, a second source/drain, a gate coupled to the input pad 110, and a bulk coupled through the resistor R1 to a specific voltage V1. The specific voltage V1 may be, for example, the work voltage VDD or the ground voltage VSS. The first source/drain and the second source/drain of the transistor MT may be coupled to other components and circuits. The detailed connections of the first source/drain and the second source/drain are not shown in FIG. 1 since they are not restricted in the invention. Note that the coupled resistor R1 provides high impedance for the bulk of the transistor MT. Accordingly, the resistor R1 can prevent an excessive electrostatic current from flowing through the gate to/from the bulk and breaking the transistor MT such that the robustness of CDM is enhanced. No CDM clamp circuit is required in the invention. The resistance of the resistor R1 is at least greater than about 200 Ω. In a preferred embodiment, the resistance of the resistor R1 is greater than about 1 kΩ.

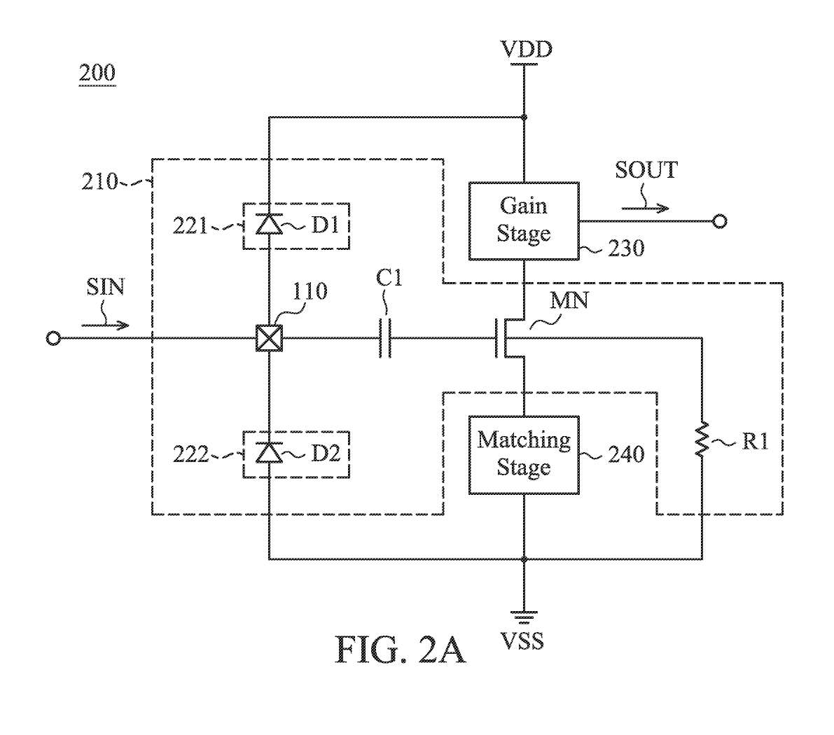

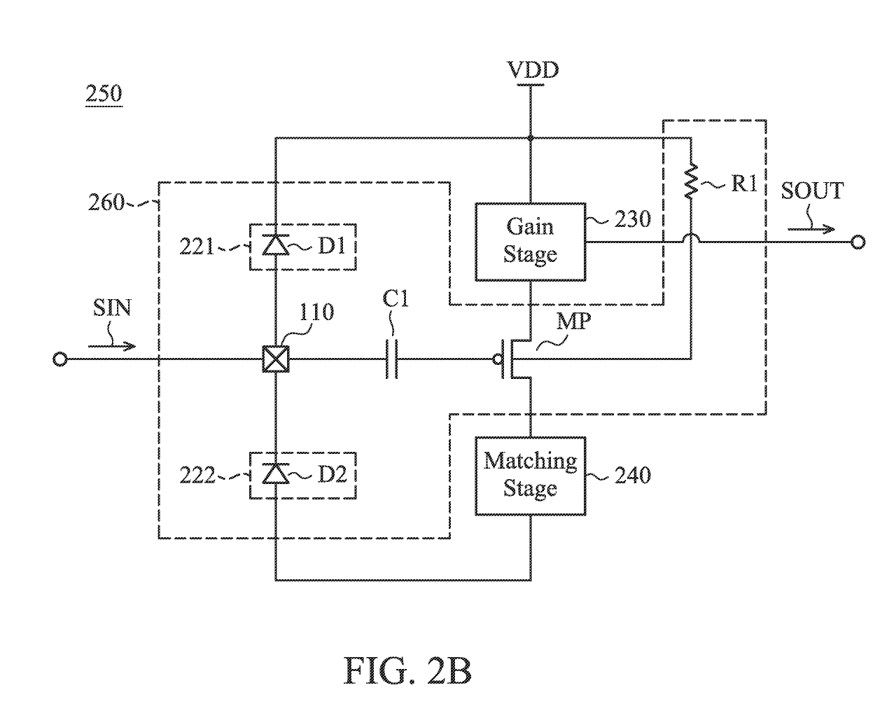

FIG. 2A is a diagram for illustrating an ESD structure 200 according to an embodiment of the invention. As shown in FIG. 2A, the ESD structure 200 comprises an input stage 210, a gain stage 230, and a matching stage 240. The input stage 210 is similar to the input stage 110 of FIG. 1. In the embodiment, the input stage 210 comprises an input pad 110, a first ESD clamp circuit 221, a second ESD clamp circuit 222, a capacitor C1, a resistor R1, and an NMOS transistor MN. The capacitor C1 is configured to reject some DC (Direct Current) noise which is input to the input pad 110. The NMOS transistor MN has a gate coupled through the capacitor C1 to the input pad 110, a source coupled to the matching stage 240, a drain coupled to the gain stage 230, and a bulk coupled through the resistor R1 to the ground voltage VSS. The resistor R1 can prevent an excessive electrostatic current from flowing through the gate to the bulk and breaking the NMOS transistor MN such that the robustness of CDM is enhanced. The first ESD clamp circuit 221 comprises a first diode D1. The first diode D1 has an anode coupled to the input pad 110, and a cathode coupled to the work voltage VDD. The second ESD clamp circuit 222 comprises a second diode D2. The second diode D2 has an anode coupled to the ground voltage VSS, and a cathode coupled to the input pad 110. By arranging the first diode D1 and the second diode D2 appropriately, the voltage level of the input pad 110 can be maintained within a narrow range. The gain stage 230 is coupled between the drain of the NMOS transistor MN and the work voltage VDD, and is configured to amplify the input signal SIN to generate an output signal SOUT. The matching stage 240 is coupled between the source of the NMOS transistor MN and the ground voltage VSS, and is configured to provide impedance matching. In the embodiment, an LNA (Low Noise Amplifier) is formed by the input stage 210, the gain stage 230, and the matching stage 240. However, the invention is not limited to the above. The ESD structure 200 and the input stage 210 therein may be applied to a variety of circuits and components to enhance the robustness of CDM.

FIG. 2B is a diagram for illustrating an ESD structure 250 according to another embodiment of the invention. FIG. 2B is similar to FIG. 2A. In the embodiment, an input stage 260 of the ESD structure 250 comprises a PMOS transistor MP, instead of the NMOS transistor MN. The PMOS transistor MP has a gate coupled through the capacitor C1 to the input pad 110, a source coupled to the gain stage 230, a drain coupled to the matching 240, and a bulk coupled through the resistor R1 to the work voltage VDD. The resistor R1 can prevent an excessive electrostatic current from flowing from the bulk through the gate and breaking the PMOS transistor MP such that the robustness of CDM is enhanced. Other features of the ESD structure 250 of FIG. 2B are almost the same as those of the ESD structure 200 of FIG. 2A. Accordingly, the two embodiments can achieve similar performances.

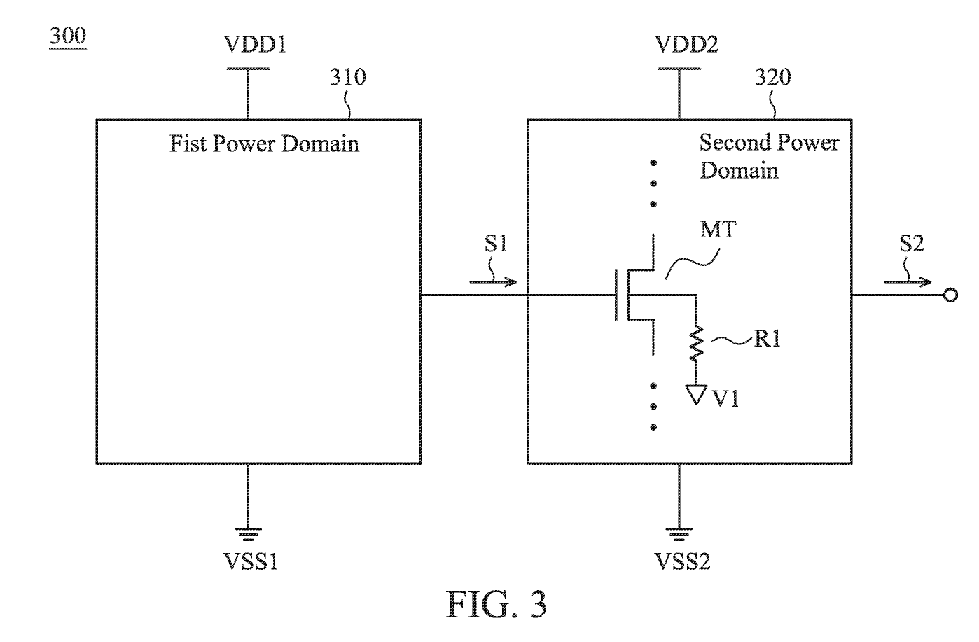

FIG. 3 is a diagram for illustrating a chip 300 with an ESD structure for enhancing robustness of CDM according to an embodiment of the invention. The chip 300 may be implemented with an IC (Integrated Circuit). As shown in FIG. 3, the chip 300 at least comprises a first power domain 310 and a second power domain 320. The first power domain 310 is supplied by a first work voltage VDD1, and generates a first signal S1. The second power domain 320 is supplied by a second work voltage VDD2, and generates a second signal S2 according to the first signal S1. In a preferred embodiment, the first work voltage VDD1 is different from the second work voltage VDD2. Furthermore, the first power domain 310 is coupled to a first ground voltage VSS1, and the second power domain 320 is coupled to a second ground voltage VSS2. In some embodiments, the first ground voltage VSS1 and the second ground voltage VSS2 may be the same or different. The second power domain 320 comprises a resistor R1 and a transistor MT. The transistor MT has a first source/drain, a second source/drain, a gate for receiving the first signal S1 from the first power domain 310, and a bulk coupled through the resistor R1 to a specific voltage V1. The specific voltage V1 may be, for example, the second work voltage VDD2 or the second ground voltage VSS2. The first source/drain and the second source/drain of the transistor MT may be coupled to other components and circuits. The detailed connections of the first source/drain and the second source/drain are not shown in FIG. 3 since they not restricted in the invention.

In some embodiments, if the transistor MT is an NMOS transistor, the NMOS transistor may have a bulk coupled through the resistor R1 to the second ground voltage VSS2. In other embodiments, if the transistor MT is a PMOS transistor, the PMOS transistor may have a bulk coupled through the resistor R1 to the second work voltage VDD2. The coupled resistor R1 provides high impedance for the bulk of the transistor MT, and accordingly enhances the robustness of CDM between the first power domain 310 and the second power domain 320. The resistance of the resistor R1 is at least greater than about 200 Ω. In a preferred embodiment, the resistance of the resistor R1 is greater than about 1 kΩ.

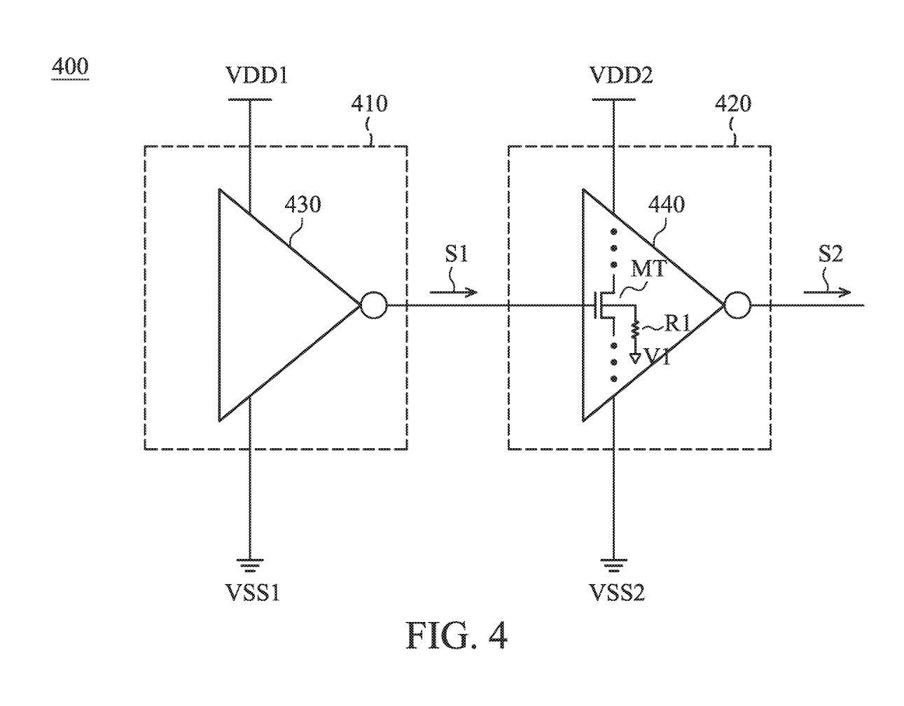

FIG. 4 is a diagram for illustrating a chip 400 according to an embodiment of the invention. As shown in FIG. 4, in the chip 400, a first power domain 410 comprises a first inverter 430, and a second power domain 420 comprises a second inverter 440. The first inverter 430 has an output terminal for outputting a first signal S1. The second inverter 440 has an input terminal for inputting the first signal S1, and an output terminal for outputting a second signal S2. In the embodiment, a transistor MT is a portion of the second inverter 440. The transistor MT has a gate coupled to the output terminal of the first inverter 430, and a bulk coupled through a resistor R1 to a specific voltage V1. Similarly, if the transistor MT is an NMOS transistor, the NMOS transistor may have a bulk coupled through the resistor R1 to the second ground voltage VSS2, and if the transistor MT is a PMOS transistor, the PMOS transistor may have a bulk coupled through the resistor R1 to the second work voltage VDD2.

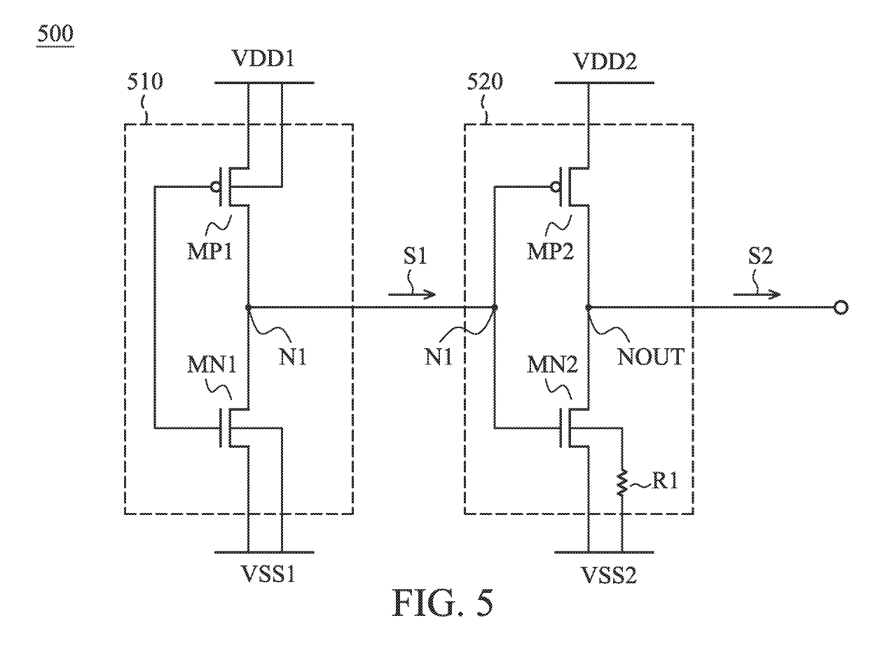

FIG. 5 is a diagram for illustrating a chip 500 according to an embodiment of the invention. As shown in FIG. 5, in the chip 500, a first power domain 510 comprises a first PMOS transistor MP1 and a first NMOS transistor MN1, and a second power domain 520 comprises a second PMOS transistor MP2 and a second NMOS transistor MN2. The first PMOS transistor MP1 has a gate for receiving an input signal (not shown), a source coupled to the first work voltage VDD1, a drain coupled to an interface node N1, and a bulk coupled to the first work voltage VDD1. The first NMOS transistor MN1 has a gate for receiving the input signal, a source coupled to the first ground voltage VSS1, a drain coupled to the interface node N1, and a bulk coupled to the first ground voltage VSS1. The second PMOS transistor MP2 has a gate coupled to the interface node N1, a source coupled to the second work voltage VDD2, a drain coupled to an output node NOUT, and a bulk coupled to the second work voltage VSS2. The second NMOS transistor MN2 has a gate coupled to the interface node N1, a source coupled to the second ground voltage VSS2, a drain coupled the output node NOUT, and a bulk coupled through a resistor R1 to the second ground voltage VSS2. In the embodiment, the first ground voltage VSS1 is different from the second ground voltage VSS2. In other embodiments, adjustments may be made wherein the bulk of the second PMOS transistor MP2 is coupled through the resistor R1 to the second work voltage VDD2.

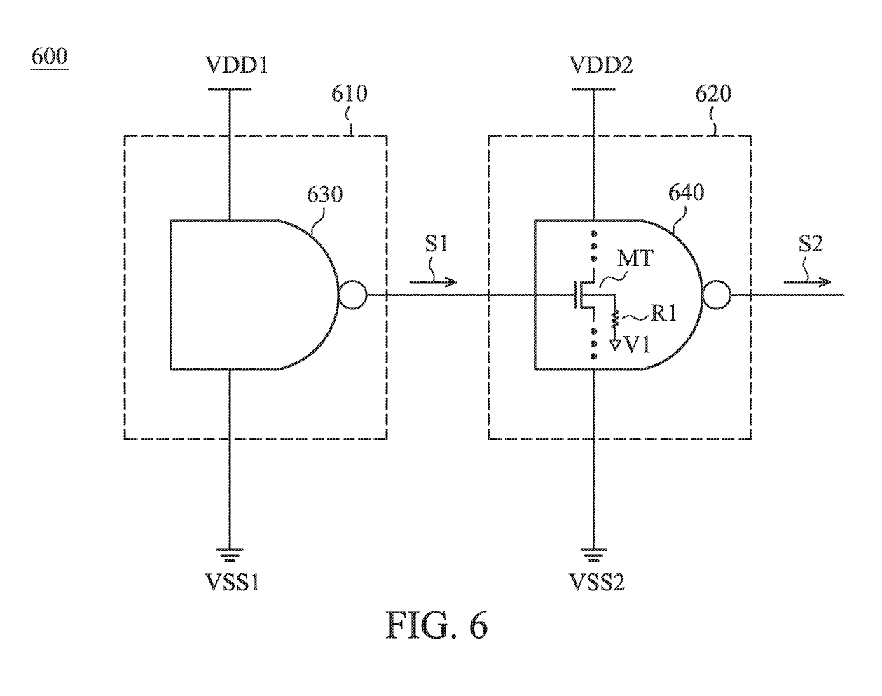

FIG. 6 is a diagram for illustrating a chip 600 according to an embodiment of the invention. As shown in FIG. 6, in the chip 600, a first power domain 610 comprises a first NAND gate 630, and a second power domain 620 comprises a second NAND gate 640. The first NAND gate 630 has an output terminal for outputting a first signal S1. The second NAND gate 640 has an input terminal for inputting the first signal S1, and an output terminal for outputting a second signal S2. Other input terminals of the NAND gates (not shown in FIG. 6) are not restricted, and may be coupled to any circuit. In the embodiment, a transistor MT is a portion of the second NAND gate 640. The transistor MT has a gate coupled to the output terminal of the first NAND gate 630, and a bulk coupled through a resistor R1 to a specific voltage V1. Similarly, if the transistor MT is an NMOS transistor, the NMOS transistor may have a bulk coupled through the resistor R1 to the second ground voltage VSS2, and if the transistor MT is a PMOS transistor, the PMOS transistor may have a bulk coupled through the resistor R1 to the second work voltage VDD2. Note that the internal components of the NAND gates are not all shown in FIG. 6 since they are well-known for one of ordinary skills in the art.

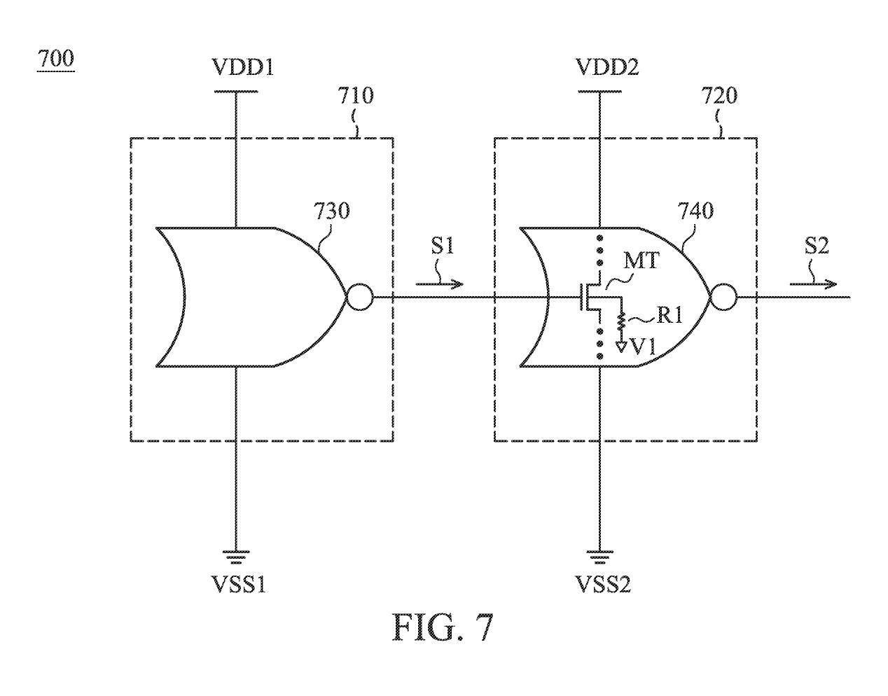

FIG. 7 is a diagram for illustrating a chip 700 according to an embodiment of the invention. As shown in FIG. 7, in the chip 700, a first power domain 710 comprises a first NOR gate 730, and a second power domain 720 comprises a second NOR gate 740. The first NOR gate 730 has an output terminal for outputting a first signal S1. The second NOR gate 740 has an input terminal for inputting the first signal S1, and an output terminal for outputting a second signal S2. Other input terminals of the NOR gates (not shown in FIG. 7) are not restricted, and may be coupled to any circuit. In the embodiment, a transistor MT is a portion of the second NOR gate 740. The transistor MT has a gate coupled to the output terminal of the first NOR gate 730, and a bulk coupled through a resistor R1 to a specific voltage V1. Similarly, if the transistor MT is an NMOS transistor, the NMOS transistor may have a bulk coupled through the resistor R1 to the second ground voltage VSS2, and if the transistor MT is a PMOS transistor, the PMOS transistor may have a bulk coupled through the resistor R1 to the second work voltage VDD2. Note that the internal components of the NOR gates are not all shown in FIG. 7 since they are well-known for one of ordinary skills in the art.

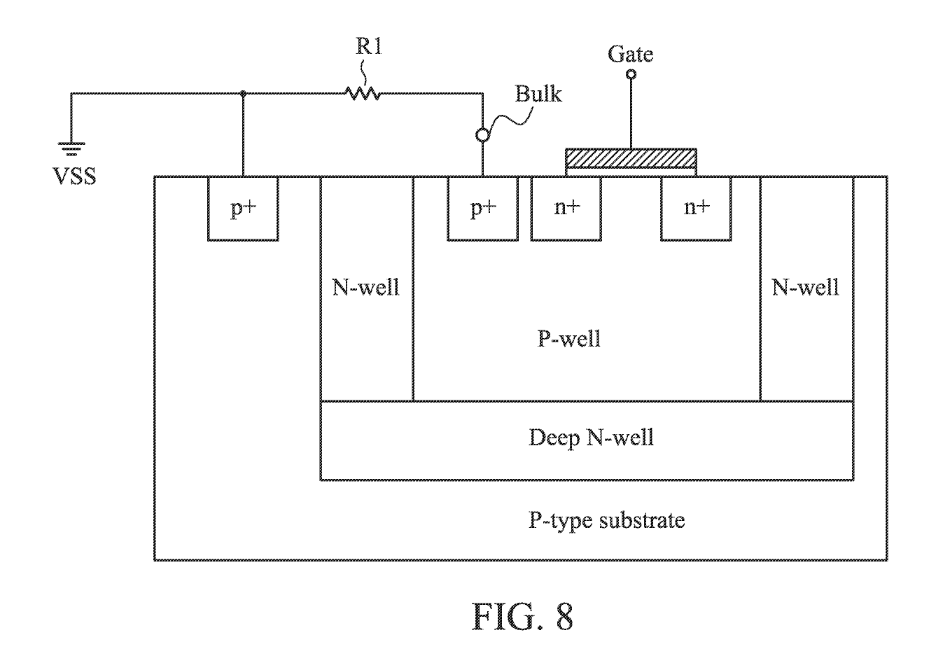

FIG. 8 is a diagram for illustrating a detail structure of an NMOS transistor and a resistor R1 coupled thereto according to an embodiment of the invention. As shown in FIG. 8, an NMOS transistor is formed by at least a p-well and two n+ doped regions. Note that the p-well and a p+ doped region therein are isolated by an n-well and a deep n-well, and accordingly a bulk of the NMOS transistor never directly touches a p-type substrate. The bulk of the NMOS transistor is coupled through a resistor R1 to a ground voltage VSS and to another p+ doped region formed in the p-type substrate. The above design can prevent the two terminals of the resistor R1 from being shorted together.

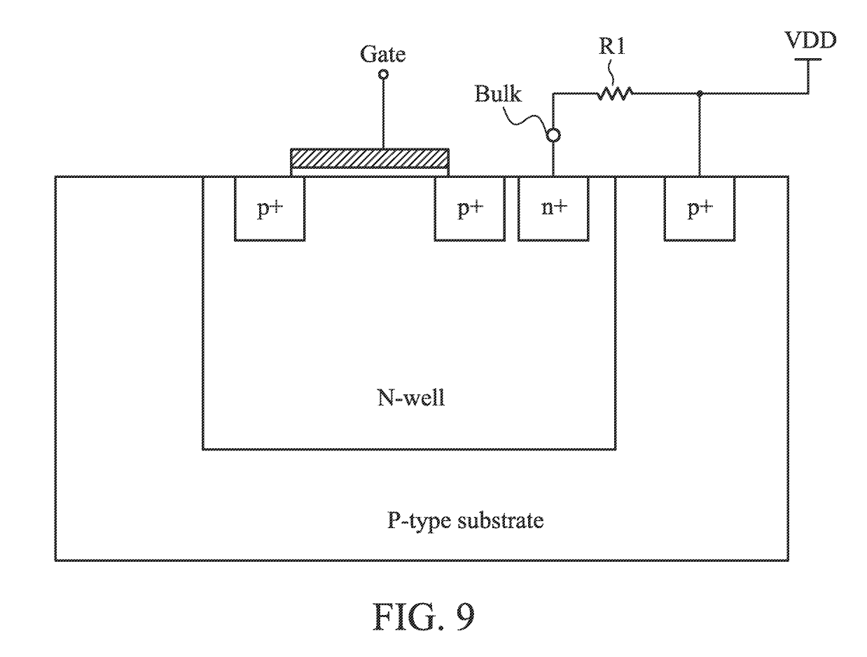

FIG. 9 is a diagram for illustrating a detail structure of a PMOS transistor and a resistor R1 coupled thereto according to an embodiment of the invention. As shown in FIG. 9, a PMOS transistor is formed by at least an n-well and two p+ doped regions. A bulk of the PMOS transistor is coupled through a resistor R1 to a work voltage VDD and to another p+ doped region formed in a p-type substrate. The structure of the PMOS transistor is simpler than that of the NMOS transistor because the n-well of the PMOS makes the bulk independent of the p-type substrate. The structures of FIGS. 8 and 9 may be applied to every embodiment which has been described above.

The invention uses a simple coupled resistor to improve robustness of CDM, and has advantages of reducing the total costs and not increasing the burden of the whole system, etc.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An ESD (Electrostatic discharge) structure, comprising:
an input stage, comprising:
an input pad, configured to receive an input signal;
a first ESD clamp circuit, coupled between the input pad and a work voltage;
a second ESD clamp circuit, coupled between the input pad and a ground voltage, wherein the first ESD clamp circuit and the second ESD clamp circuit are capable of bypassing an excessive electrostatic current;
a resistor; and
a transistor, wherein the transistor has a first source/drain, a second source/drain, a gate coupled to the input pad, and a bulk coupled to the work voltage or the ground voltage through the resistor.

2. The ESD structure as claimed in claim 1, wherein the input stage further comprises a capacitor, and the gate of the transistor is coupled through the capacitor to the input pad.

3. The ESD structure as claimed in claim 1, further comprising:
a gain stage, coupled between the first source/drain of the transistor and the work voltage, and configured to amplify the input signal to generate an output signal; and
a matching stage, coupled between the second source/drain of the transistor and the ground voltage, and configured to provide impedance matching.

4. The ESD structure as claimed in claim 3, wherein an LNA (Low Noise Amplifier) is formed by the input stage, the gain stage, and the matching stage.

5. The ESD structure as claimed in claim 1, wherein the first ESD clamp circuit comprises a first diode, and the first diode has an anode coupled to the input pad and a cathode coupled to the work voltage.

6. The ESD structure as claimed in claim 1, wherein the second ESD clamp circuit comprises a second diode, and the second diode has an anode coupled to the ground voltage and a cathode coupled to the input pad.

7. The ESD structure as claimed in claim 1, wherein the bulk of the transistor is coupled through the resistor to the ground voltage, and the transistor is an NMOS transistor (N-channel Metal-Oxide-Semiconductor Field-Effect Transistor).

8. The ESD structure as claimed in claim 1, wherein the bulk of the transistor is coupled through the resistor to the work voltage, and the transistor is a PMOS transistor (P-channel Metal-Oxide-Semiconductor Field-Effect Transistor).

9. The ESD structure as claimed in claim 1, wherein a resistance of the resistor is greater than about 200 Ω.

10. The ESD structure as claimed in claim 1, wherein a resistance of the resistor is greater than about 1 kΩ.

11. A chip with an ESD (Electrostatic discharge) structure, comprising:
a first power domain, supplied by a first work voltage, and generating a first signal; and
a second power domain, supplied by a second work voltage, and generating a second signal according to the first signal, wherein the second power domain comprises:
a resistor; and
a transistor, wherein the transistor has a first source/drain, a second source/drain, a gate for receiving the first signal, and a bulk coupled to the second work voltage or a ground voltage through the resistor.

12. The chip as claimed in claim 11, wherein the first work voltage is different from the second work voltage.

13. The chip as claimed in claim 11, wherein the bulk of the transistor is coupled through the resistor to the ground voltage, and the transistor is an NMOS transistor (N-channel Metal-Oxide-Semiconductor Field-Effect Transistor).

14. The chip as claimed in claim 11, wherein the bulk of the transistor is coupled through the resistor to the second work voltage, and the transistor is a PMOS transistor (P-channel Metal-Oxide-Semiconductor Field-Effect Transistor).

15. The chip as claimed in claim 11, wherein a resistance of the resistor is greater than about 200 Ω.

16. The chip as claimed in claim 11, wherein a resistance of the resistor is greater than about 1 kΩ.

17. The chip as claimed in claim 11, wherein the first power domain comprises a first inverter having an output terminal for outputting the first signal, the second power domain comprises a second inverter having an input terminal for inputting the first signal and an output terminal for outputting the second signal, the transistor is a portion of the second inverter, and the gate of the transistor is coupled to the output terminal of the first inverter.

18. The chip as claimed in claim 11, wherein the transistor is a second NMOS transistor (N-channel Metal-Oxide-Semiconductor Field-Effect Transistor), the ground voltage is a second ground voltage, the first power domain comprises a first PMOS transistor (P-channel Metal-Oxide-Semiconductor Field-Effect Transistor) and a first NMOS transistor, the first PMOS transistor has a gate, a source coupled to the first work voltage, a drain coupled to an interface node, and a bulk coupled to the first work voltage, the first NMOS transistor has a gate, a source coupled to a first ground voltage, a drain coupled to the interface node, and a bulk coupled to the first ground voltage, the first ground voltage is different from the second ground voltage, the second power domain comprises a second PMOS transistor and the second NMOS transistor, the second PMOS transistor has a gate coupled to the interface node, a source coupled to the second work voltage, a drain coupled to an output node, and a bulk coupled to the second work voltage, the second NMOS transistor has a gate coupled to the interface node, a source coupled to the second ground voltage, a drain coupled the output node, and a bulk coupled through the resistor to the second ground voltage.

19. The chip as claimed in claim 11, wherein the first power domain comprises a first NAND gate having an output terminal for outputting the first signal, the second power domain comprises a second NAND gate having an input terminal for inputting the first signal and an output terminal for outputting the second signal, the transistor is a portion of the second NAND gate, and the gate of the transistor is coupled to the output terminal of the first NAND gate.

20. The chip as claimed in claim 11, wherein the first power domain comprises a first NOR gate having an output terminal for outputting the first signal, the second power domain comprises a second NOR gate having an input terminal for inputting the first signal and an output terminal for outputting the second signal, the transistor is a portion of the second NOR gate, and the gate of the transistor is coupled to the output terminal of the first NOR gate.
